(19) United States
(12) Patent Application Publication
(10) Pub. No.: US 2023/0094099 A1
(43) Pub. Date: Mar. 30, 2023

(54) Detection System

(71) Applicants: Tyco Electronics (Shanghai) Co., Ltd., Shanghai (CN); TE Connectivity Solutions GmbH, Schaffhausen (CH)

(72) Inventors: Qing (Carrie) Zhou, Shanghai (CN); Dandan (Emily) Zhang, Shanghai (CN); Roberto Francisco-Yi Lu, Bellevue, WA (US); Lei (Alex) Zhou, Shanghai (CN)

(73) Assignees: Tyco Electronics (Shanghai) Co., Ltd., Shanghai (CN); TE Connectivity Solutions GmbH, Schaffhausen (CH)

(21) Appl. No.: 17/956,030

(22) Filed: Sep. 29, 2022

(30) Foreign Application Priority Data
Sep. 29, 2021 (CN) 202111152833.6

(51) Int. Cl. H01R 43/048; G06T 7/00; G06T 7/62

(52) U.S. Cl. CPC H01R 43/0488; G06T 7/0004; G06T 7/62; G06T 2207/30164

(57) ABSTRACT

A detection system includes an imaging device and a control device connected in communication with the imaging device. The imaging device captures a 3D image of a connector including a housing, a terminal, and a cable. The control device calculates a height of a connection end of the cable crimped to the terminal relative to a bottom surface of the housing according to the 3D image.

### CROSS-REFERENCE TO RELATED APPLICATION

This application claims the benefit of the filing date under 35 U.S.C. § 119(a)-(d) of Chinese Patent Application No. 202111152833.6, filed on Sep. 29, 2021.

### FIELD OF THE INVENTION

The present invention relates to a detection system, in particular to a detection system for detecting a height of a cable of a connector relative to a bottom surface of a housing of the connector.

### BACKGROUND

In the prior art, a connector usually includes a housing, a terminal, and a cable. The terminal is installed in the housing, the connection end of the cable is crimped to the terminal, and a protrusion on the terminal pierces the insulating layer of the cable and makes electrical contact with the conductor inside the cable. In order to ensure that the terminal can be reliably connected with the conductor of the cable, the connection end of the cable must be pressed into the predetermined position in the terminal. If the connection end of the cable is not crimped in place, there will be problems of unreliable contact between the terminal and the conductor of the cable, which will affect the quality of the connector.

Therefore, in the prior art, after the cable is crimped into the terminal, workers need to use special contact tools to detect whether the connection end of the cable is crimped in place. However, the efficiency and accuracy of manual detection are very low.

### SUMMARY

A detection system includes an imaging device and a control device connected in communication with the imaging device. The imaging device captures a 3D image of a connector including a housing, a terminal, and a cable. The control device calculates a height of a connection end of the cable crimped to the terminal relative to a bottom surface of the housing according to the 3D image.

### BRIEF DESCRIPTION OF THE DRAWINGS

The features of the present invention will become more apparent by describing in detail exemplary embodiments thereof with reference to the accompanying drawings, in which:

FIG. 1 is a schematic diagram of a detection system according to an embodiment;

FIG. 2 is a perspective view of a connector according to an embodiment;

FIG. 3 is a sectional side view of the connector of FIG. 2;

FIG. 4 is a perspective view of extracting a plurality of top areas on the top of the cable of the connector shown in FIG. 2;

FIG. 5 is a perspective view of a connector according to another embodiment; and

FIG. 6 is a perspective view of a connector according to another embodiment.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

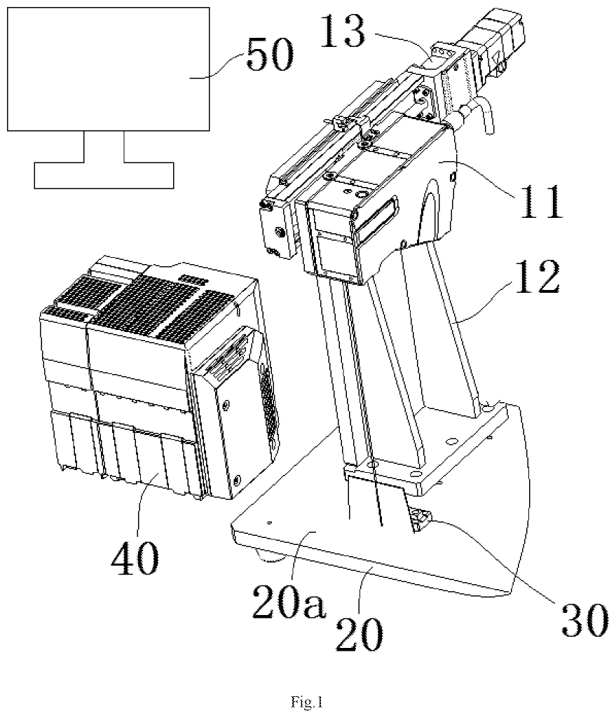

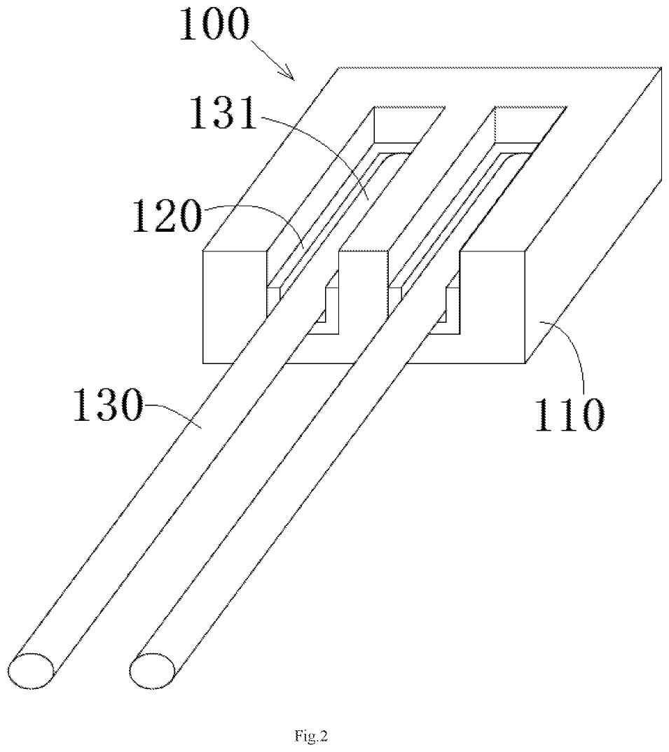

As shown in the embodiment of FIG. 1, the detection system includes an imaging device 11, 12, 13 and a control device 40. The imaging device 11, 12, and 13 is used to capture 3D images of a connector 100, shown in FIG. 2. The control device 40 is connected in communication with the imaging device 11, 12, and 13.

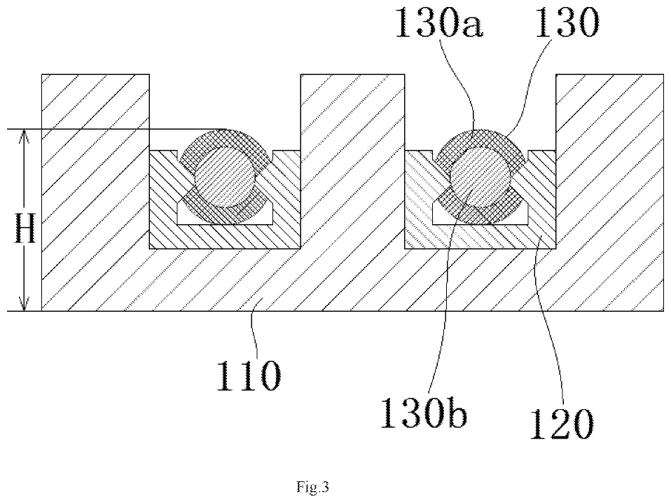

FIG. 3 shows a sectional view of the connector 100 shown in FIG. 2. As shown in FIGS. 2 and 3, in the illustrated embodiment, the connector 100 includes a housing 110, a terminal 120, and a cable 130. The terminal 120 is installed in housing 110. A connection end 131 of the cable 130 is crimped into the terminal 120. A protrusion on the terminal 120 punctures an outer insulating layer 130a of the cable 130 and makes electrical contact with a conductor 130b of the cable 130.

The control device 40 calculates a height H of the connection end 131 of the cable 130 crimped to the terminal 120 relative to a bottom surface of the housing 110, shown in FIG. 3, according to a captured 3D image. According to the detected height H, it can be determined whether the connection end 131 of the cable 130 is crimped in place. If the detected height H of the connection end 131 of the cable 130 is greater than a predetermined height, it indicates that the connection end 131 of the cable 130 is not crimped in place. If the detected height H of the connection end 131 of the cable 130 is not greater than the predetermined height, it indicates that the connection end 131 of the cable 130 has been crimped in place, and the connection end 131 of the cable 130 has been reliably connected with the terminal 120.

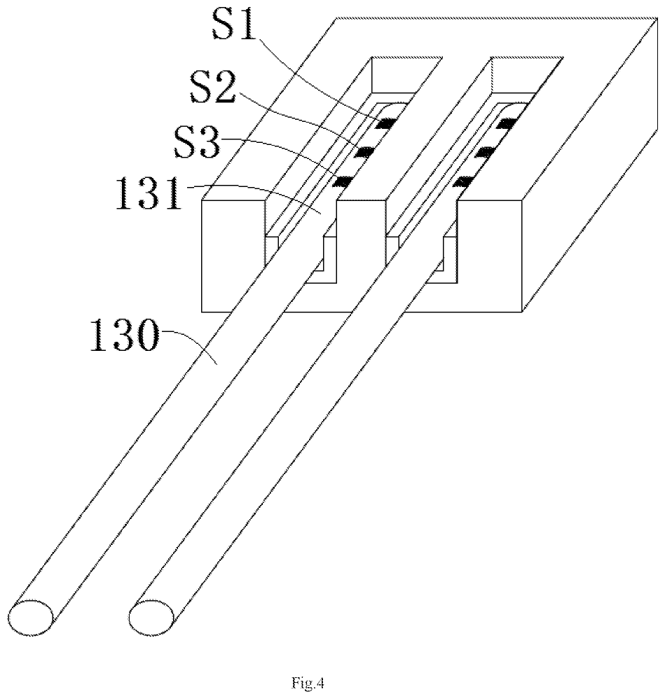

FIG. 4 shows an illustrative view of extracting a plurality of top areas S1, S2, S3 on the top of the cable 130 of the connector 100 shown in FIG. 2. The control device 40 includes an image processing device and a height calculation device. The control device 40 may be a functional device composed of hardware and software, for example, a personal computer or an industrial computer. The image processing device and the height calculation device are functional modules running in the control device 40.

The image processing device extracts a plurality of top areas S1, S2, S3 on the connection end 131 of the cable 130 from the captured 3D image. In the illustrated embodiment, the plurality of top areas S1, S2, S3 are evenly spaced in the axial direction of the connection end 131 of the cable 130. The height calculation device is suitable for calculating the heights H1, H2 and H3 of the plurality of top areas S1, S2 and S3 relative to the bottom surface of the housing 110, and taking the largest of the calculated heights H1, H2 and H3 of the plurality of top areas S1, S2 and S3 as the height H of the connection end 131 of the cable 130.

The detection system also includes a support platform 20, shown in FIG. 1, which has a reference plane 20a. The bottom surface of the housing 110 is supported on the reference plane 20a of the support platform 20 so that they are at the same height. The imaging device 11, 12, and 13 simultaneously capture 3D images of the connection end 131 of the cable 130 and the reference plane 20a of the support platform 20 from the top of the housing 110. Because the bottom surface of the housing 110 cannot be photographed, in the process of calculating the height H of the connection end 131 of the cable 130, the control device 40 replaces the bottom surface of the housing 110 with the reference plane 20a of the support platform 20.

As shown in FIG. 1, the detection system also includes a carrier 30, which is installed on the support platform 20. The connector 100 is loaded and positioned on the carrier 30 to prevent the connector 100 from being moved during the detection process.

As shown in FIG. 1, in the illustrated embodiment, the detection system also includes a display device 50, which is connected in communication with the control device 40 to display 3D images captured by the imaging device 11, 12 and 13 and the calculation results of the control device 40. The imaging device 11, 12, and 13 includes a 3D camera 11 and a bracket 12. The bracket 12 is installed on the support platform 20. The 3D camera 11 is mounted on the bracket 12 and is connected in communication with the control device 40. The 3D camera 11 is movably mounted on the bracket 12 and can be moved along the axial direction of the connection end 131 of the detected cable 130 to scan and capture the 3D images of the entire connection end 131 of the cable 130. The imaging device 11, 12 and 13 also includes a servo driver 13, which is mounted on the bracket 12 to drive the 3D camera 11 to move along the aforementioned axial direction. The control device 40 is connected in communication with the servo driver 13 to control the servo driver 13. The servo driver 13 may be a servo motor drive mechanism.

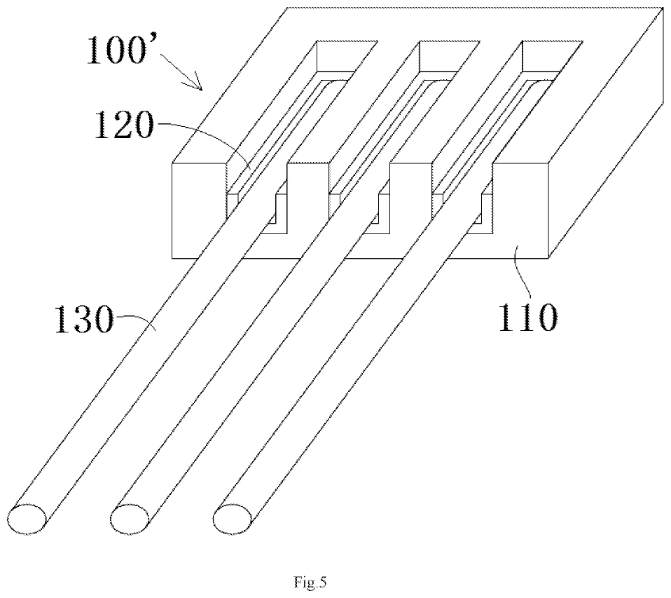

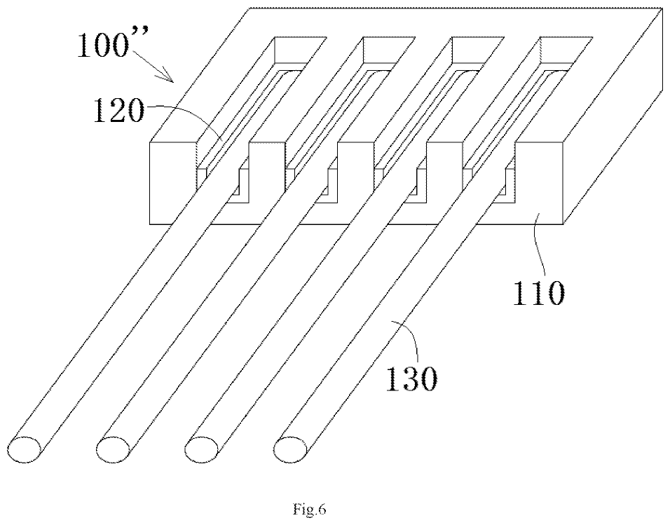

FIG. 5 shows a connector 100′ according to another exemplary embodiment of the present invention, and FIG. 6 shows a connector 100″ according to a further exemplary embodiment of the present invention.

The detection system of the present invention can detect a variety of different types of connectors, such as connector 100 shown in FIG. 2, connector 100′ shown in FIG. 5 and connector 100″ shown in FIG. 6. FIG. 2, FIG. 5, and FIG. 6 show three different connectors. However, the types of connectors are not limited to the three different connectors shown in the figures, but can also include other types of connectors.

Each type of connector 100, 100′, 100″ has a unique corresponding identification code. The image processing device includes a variety of image recognition modules respectively corresponding to different types of connectors 100, 100′ and 100″, respectively. The height calculation device 40 includes a variety of height calculation modules respectively corresponding to different types of connectors 100, 100′, 100″. The identification codes of different types of connectors 100, 100′, 100″ are stored in the control device 40 in advance, and the control device 40 calls the corresponding image recognition module and the corresponding height calculation module according to the input identification code of the connector 100.

The variety of image recognition modules and the variety of height calculation modules are stored in the control device 40 in advance. If the identification code, the image recognition module and the height calculation module corresponding to the currently detected connector are not stored in the control device 40, the identification code, the image recognition module and the height calculation module corresponding to the currently detected connector need to be established first.

The image recognition module uses artificial intelligence image recognition technology to recognize the captured 3D image. For example, the 3D sample images of the connector 100 are pre-stored in the control device 40, and the image recognition module recognizes the captured 3D image by comparing the captured 3D image with the pre stored 3D sample images. The present invention can adopt any image recognition technology in the prior art to recognize the captured 3D image.

In an embodiment, the control device 40 also includes a cable crimping quality judgment module. The cable crimping quality judgment module is a functional module running in the control device 40, which is suitable for judging whether the connection end 131 of the cable 130 is crimped in place according to the detected height H of the connection end 131 of the cable 130. When the detected height H of the connection end 131 of the cable 130 is greater than a predetermined height, the cable crimping quality judgment module determines that the connection end 131 of the cable 130 is not crimped in place. When the detected height H of the connection end 131 of the cable 130 is not greater than the predetermined height, the cable crimping quality judgment module determines that the connection end 131 of the cable 130 has been crimped in place.

As shown in FIGS. 2-6, the connector 100 includes a plurality of terminals 120 and a plurality of cables 130 crimped to the plurality of terminals 120, respectively. The detection system is suitable for detecting the heights H of the connection ends 131 of the plurality of cables 130 at the same time. In this way, the detection efficiency can be improved.

In the above exemplary embodiments according to the present invention, the detection system can automatically detect the height of the connection end of the cable relative to the bottom surface of the housing in a non-contact manner, so it can easily detect whether the connection end of the cable is crimped in place.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A detection system, comprising:
an imaging device capturing a 3D image of a connector including a housing, a terminal, and a cable; and
a control device connected in communication with the imaging device, the control device calculates a height of a connection end of the cable crimped to the terminal relative to a bottom surface of the housing according to the 3D image.

2. The detection system of claim 1, wherein the control device includes an image processing device extracting a plurality of top areas on the connection end of the cable from the 3D image, the plurality of top areas are evenly spaced in an axial direction of the connection end of the cable.

3. The detection system of claim 2, wherein the control device includes a height calculation device calculating a plurality of heights of the plurality of top areas relative to the bottom surface of the housing.

4. The detection system of claim 3, wherein the height calculation device takes a largest of the heights of the plurality of top areas as a height of the connection end of the cable.

5. The detection system of claim 1, further comprising a support platform having a reference plane, the bottom surface of the housing is supported on the reference plane of the support platform, so that the bottom surface and the reference plane have a same height.

6. The detection system of claim 5, wherein the imaging device simultaneously takes the 3D image of the connection end of the cable and the reference plane of the support platform from a top of the housing, and in calculating the height of the connection end of the cable, the control device replaces the bottom surface of the housing with the reference plane of the support platform.

7. The detection system of claim 6, further comprising a carrier installed on the support platform, the connector is loaded and positioned on the carrier to prevent the connector from being moved during detection.

8. The detection system of claim 5, further comprising a display device connected in communication with the control device to display the 3D image captured by the imaging device and a calculation result of the control device.

9. The detection system of claim 6, wherein the imaging device includes a bracket mounted on the support platform and a 3D camera mounted on the bracket, the 3D camera is connected in communication with the control device.

10. The detection system of claim 9, wherein the 3D camera is movably mounted on the bracket and is movable along an axial direction of the connection end of the cable to capture the 3D image of an entirety of the connection end.

11. The detection system of claim 10, wherein the imaging device includes a servo driver installed on the bracket to drive the 3D camera to move along the axial direction, the control device is connected in communication with the servo driver to control the servo driver.

12. The detection system of claim 3, wherein the connector is one of a plurality of different types of connectors each having a unique corresponding identification code, the identification codes of different types of connectors are pre-stored in the control device.

13. The detection system of claim 12, wherein the image processing device includes a variety of image recognition modules respectively corresponding to the different types of connectors, the height calculation device includes a variety of height calculation modules respectively corresponding to the different types of connectors, and the control device calls the corresponding image recognition module and the corresponding height calculation module according to the identification code of the connector.

14. The detection system of claim 13, wherein the plurality of image recognition modules and the plurality of height calculation modules are pre-stored in the control device, the image recognition modules use artificial intelligence image recognition technology to recognize the 3D image.

15. The detection system of claim 14, wherein a plurality of 3D sample images of the connector are pre-stored in the control device, the image recognition modules recognize the 3D image by comparing the 3D image with the 3D sample images.

16. The detection system of claim 1, wherein the control device includes a cable crimping quality judgment module judging whether the connection end of the cable is crimped in place according to the height of the connection end of the cable.

17. The detection system of claim 16, wherein, when the height of the connection end of the cable is greater than a predetermined height, the cable crimping quality judgment module determines that the connection end of the cable is not crimped in place.

18. The detection system of claim 17, wherein, when the height of the connection end of the cable is not greater than the predetermined height, the cable crimping quality judgment module determines that the connection end of the cable has been crimped in place.

19. The detection system of claim 1, wherein the terminal is one of a plurality of terminals of the connector and the cable is one of a plurality of cables connected to the connector, the cables are respectively crimped to the terminals, the detection system detects the height of the connection end of each of the plurality of cables at a same time.

20. The detection system of claim 1, wherein the control device is a personal computer or an industrial computer.
